(19) United States
(12) Patent Application Publication
(10) Pub. No.: US 2008/0231552 A1
(43) Pub. Date: Sep. 25, 2008

(54) PLASMA DISPLAY APPARATUS

(76) Inventors: Yoon Chang Choi, Gumi-si (KR); Won Jae Kim, Gumi-si (KR); Chi Yun Ok, Gumi-si (KR); Dong Soo Lee, Gumi-si (KR)

Correspondence Address: KED & ASSOCIATES, LLP, P.O. Box 221200, Chantilly, VA, 20153-1200, US

(21) Appl. No.: 11/972,264

(22) Filed: Jan. 10, 2008

(30) Foreign Application Priority Data
Mar. 20, 2007 (KR) 10-2007-0027322

(51) Int. Cl. G09G 3/28; G06F 3/038

(52) U.S. Cl. 345/60; 345/211

(57) ABSTRACT

A plasma display apparatus includes a plasma display panel (PDP) including a front panel with a plurality of scan electrodes and sustain electrodes formed thereon and a rear panel with a plurality of address electrodes formed thereon and a driving circuit that applies drive signals to the scan, sustain and address electrodes so that driving can be performed by time-division of one frame of an image displayed on the PDP into a plurality of sub-fields. Each sub-field includes reset, address, and sustain periods, and a first signal that gradually falls is applied to the scan electrodes during the address period.

In the plasma display apparatus, after a rising signal and a falling signal are applied to the scan electrodes, the first signal is applied before or after the scan signal is applied during the address period, thereby preventing a loss of wall charges and performing stable address discharges and sustain discharges.

This Nonprovisional application claims priority under 35 U.S.C. § 119(a) on Patent Application No. 10-2007-0027322 filed in Republic of Korea on Mar. 20, 2007, the entire contents of which are hereby incorporated by reference.

### BACKGROUND OF THE INVENTION

1. Field of the Invention

The present invention relates to a plasma display apparatus and its driving method, and more particularly, to a plasma display apparatus capable of preventing a loss of wall charges before address discharges.

2. Description of the Related Art

In general, a plasma display apparatus is advantageous in that it can be easily increased in size, can become easily thinner, can be easily fabricated owing to its simple structure, and has high luminance and luminous efficiency compared with other flat panel display devices.

In the plasma display apparatus, a certain voltage is applied to at least one electrode formed at a discharge space of a plasma display panel (PDP) and phosphor is excited by plasma generated during discharge to thus display images.

### SUMMARY OF THE INVENTION

An object of the present invention is to provide a plasma display apparatus capable of preventing a loss of wall charges before address discharges.

To achieve the above object, there is provided a plasma display driving method in which a plurality of scan electrodes of a plasma display panel are divided into first and second blocks, a single frame of an image displayed on the plasma display panel includes at least one sub-field including at least one of a reset period, an address period, and a sustain period, and a first signal having a gradually falling potential (a voltage value) is applied to at least one scan electrode included in at least one of the first and second blocks before a scan pulse is applied.

To achieve the above object, there is also provided a plasma display apparatus including: a plasma display panel that displays an image based on at least one sub-field including at least one of a reset period, an address period, and a sustain period and includes a plurality of scan electrodes divided into first and second blocks; and a scan driving circuit that applies respective drive signals to at least one scan electrode included in each of the first and second blocks, wherein the scan driving circuit includes a first scan driver that applies the drive signals to at least one scan electrode included in the first block and a second scan driver that applies a first signal having a gradually reduced voltage value to at least one scan electrode included in the second block before a scan signal, among the drive signals, is applied.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a first embodiment of a structure of a plasma display panel (PDP) according to the present invention.

FIGS. 2A to 3B are sectional views showing embodiments of the sectional structure of the PDP according to the present invention.

FIG. 4 is a layout view showing a first embodiment of an electrode disposition of the PDP according to the present invention.

FIG. 5 is a timing view showing a first embodiment of a method of time division of one frame into several sub-fields.

FIG. 6 is a circuit diagram showing a first embodiment of a scan driving circuit of a plasma display apparatus according to the present invention.

FIG. 7 is a timing view showing a first embodiment of driving waveforms of the PDP according to the present invention.

FIG. 8 is a circuit diagram showing an operation of the scan driving circuit when a falling signal and a first signal are applied in the first embodiment of FIG. 7.

FIG. 9 is a timing view showing a second embodiment of driving waveforms of the PDP according to the present invention.

FIG. 10 is a circuit diagram showing operations of the scan driving circuit when the falling signal and first and third signals are applied in the second embodiment of FIG. 9.

FIG. 11 is a timing view showing a third embodiment of driving waveforms of the PDP according to the present invention.

FIG. 12 is a timing view showing a fourth embodiment of driving waveforms of the PDP according to the present invention.

FIG. 13 is a timing view showing a fifth embodiment of driving waveforms of the PDP according to the present invention.

FIG. 14 is a timing view showing a sixth embodiment of driving waveforms of the PDP according to the present invention.

FIG. 15 is a timing view showing a seventh embodiment of driving waveforms of the PDP according to the present invention.

FIG. 16 is a timing view showing an eighth embodiment of driving waveforms of the PDP according to the present invention.

FIG. 17 is a timing view showing a ninth embodiment of driving waveforms of the PDP according to the present invention.

FIG. 18 is a timing view showing a tenth embodiment of driving waveforms of the PDP according to the present invention.

FIG. 19 is a timing view showing an eleventh embodiment of driving waveforms of the PDP according to the present invention.

### DETAILED DESCRIPTION OF THE PREFERRED EMBODIMENT

Preferred embodiments of a plasma display apparatus according to the present invention will be described in detail with reference to the accompanying drawings.

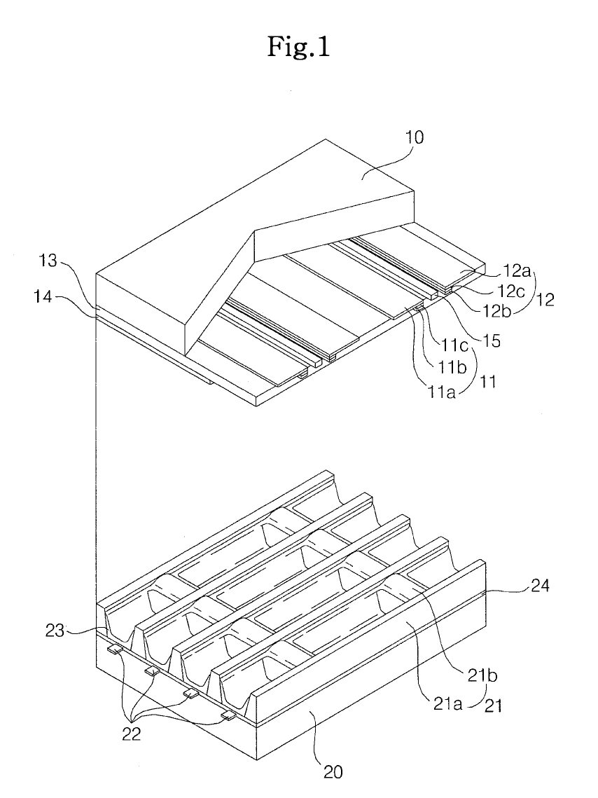

FIG. 1 is a perspective view showing a first embodiment of a structure of a plasma display panel (PDP) according to the present invention.

With reference to FIG. 1, the PDP according to the present invention includes scan electrodes 11 and sustain electrodes 12, pairs of storage electrodes, formed on an upper substrate 10 and address electrodes 22 formed on a lower substrate 20.

The pair of storage electrodes 11 and 12 may include transparent electrodes 11a and 12a and bus electrodes 11b and 12b generally made of indium-tin-oxide (ITO). The bus electrodes 11b and 12b may be made of metal such as Ag and Cr, etc., or may be formed as a stacking type of chromium/copper/chromium (Cr/Cu/Cr) or chromium/aluminum/chromium (Cr/Al/Cr). The bus electrodes 11b and 12b are formed on the transparent electrodes 11a and 12a and serve to reduce a voltage drop caused by the transparent electrodes 11a and 12a with high resistance.

By forming the pairs of storage electrodes 11 and 12, e.g., the transparent electrodes 11a and 12a to have a distance therebetween within the range of 100 μm to 300 μm, luminance of the PDP can be improved.

The pairs of the storage electrodes 11 and 12 may include only the bus electrodes 11b and 12b without the transparent electrodes 11a and 12a as well as include the stacked structure of the transparent electrodes 11a and 12a and the bus electrodes 11b and 12b. In this case, without the transparent electrodes 11a and 12a, fabrication costs of the PDP can be reduced and fabrication processes of the PDP can be simplified.

Black matrixes 11c, 12c, and 15 are formed between the transparent electrodes 11a and 12a and the bus electrodes 11b and 12b of the scan electrodes 11 and the sustain electrodes 12 and perform a light blocking function of absorbing external light generated from the exterior of the upper substrate 10 to thus reduce light reflection and a function of improving purity and contrast of the upper substrate 10.

In the first embodiment of the present invention, the black matrixes are formed on the upper substrate 10 and include a first black matrix 15 formed at a position overlapping with a barrier rib 21 and second black matrixes 11c and 12c formed between the transparent electrodes 11a and 12a and the bus electrodes 11b and 12b. Here, the first black matrix 15 and the second black matrixes 11c and 12c, which are also called a black layer or a black electrode layer, can be simultaneously formed in their formation process and physically connected, or may not be simultaneously formed and thus not be physically connected.

When the black matrixes are physically connected, the black matrix 15 and the black layers 11c and 12c are made of the same material, whereas when the black matrixes are formed to be physically separated, they can be made of different materials.

Charged particles generated by discharges are accumulated in an upper dielectric layer 13, and the upper dielectric layer 13 serve to protect the pairs of storage electrodes 11 and 12.

A protection layer 14 protects the upper dielectric layer 13 against sputtering of the charged particles generated during discharging, and increases secondary electron emission efficiency.

Although not shown in FIG. 1, the scan electrode 11 and the sustain electrode 12 may be formed on a certain black layer without directly contacting with the upper substrate 10.

Namely, because the black layers are formed between the upper substrate 10 and the scan electrodes 11 and the sustain electrodes 12, the upper substrate 10 does not directly contact with the scan electrode 11 and the sustain electrode 12, and thus, discoloration of the upper substrate 10, which otherwise would occur, can be prevented.

The address electrodes 22 are formed to cross the scan electrodes 11 and the sustain electrodes 12. In addition, on the lower substrate 10 with the address electrodes 22 formed thereon, there are also formed a lower dielectric layer 24 and barrier ribs 21.

In addition, phosphor layers 23 are formed on the surfaces of the lower dielectric layer 24 and the barrier ribs 21. The barrier ribs 21 include vertical barrier ribs 21a and horizontal barrier ribs 21b formed in a closed pattern, and physically divide the discharge cells.

Unlike the structure of the barrier ribs 21 in the first embodiment of the present invention as shown in FIG. 1, the barrier ribs 21 may have diverse structures. For example, the barrier ribs may have a differential barrier rib structure in which the vertical barrier ribs 21a and the horizontal barrier ribs 21b have each different height, a channel type barrier rib structure in which channels that may be used as exhaust passages are formed at one or more of the vertical barrier ribs 21 or the horizontal barrier ribs 21b, or a hollow type barrier rib structure in which hollows are formed at one or more of the vertical barrier ribs 21a or the horizontal barrier ribs 21b.

The pitches and widths of the phosphor layers 23 of the R, G, and B discharge cells may be substantially the same or different In addition, the phosphor layers 23 may have a symmetrical structure with substantially the same pitches or may have an asymmetrical structure with each different pitch. In case where the widths of the phosphor layers 23 at the respective R, G, and B discharge cells are different, the widths of the phosphor layers 23 of the G or B discharge cells may be larger than the width of the phosphor layer 23 of the R discharge cell.

The phosphor layers 23 is illuminated by ultraviolet rays generated during a gas discharge to generate visible light of one of red (R), green (G), and blue (B). Here, an inert mixture gas such as He+Xe, Ne+Xe, and He+Ne+Xe, etc., for discharging is injected into the discharge spaces provided between the upper and lower substrates 10 and 20 and the barrier ribs 21.

In the first embodiment of the present invention, the pitches of the R, G, and B discharge cells of the PDP may be substantially the same, or may be different in order to adjust color temperature at the R, G, and B discharge cells. In this case, the pitches of the R, G, and B discharge cells may be all different, or only the pitch of a discharge cell expressing a single color among the R, G, and B discharge cells may be different.

For example, the pitches of the G and B discharge cells may be larger than the pitch of the R discharge cell.

The address electrodes 22 formed on the lower substrate 20 may have substantially the uniform width and thickness, respectively, and width or thickness of the address electrodes 22 within the discharge cells may be different from those of the address electrode outside the discharge cells.

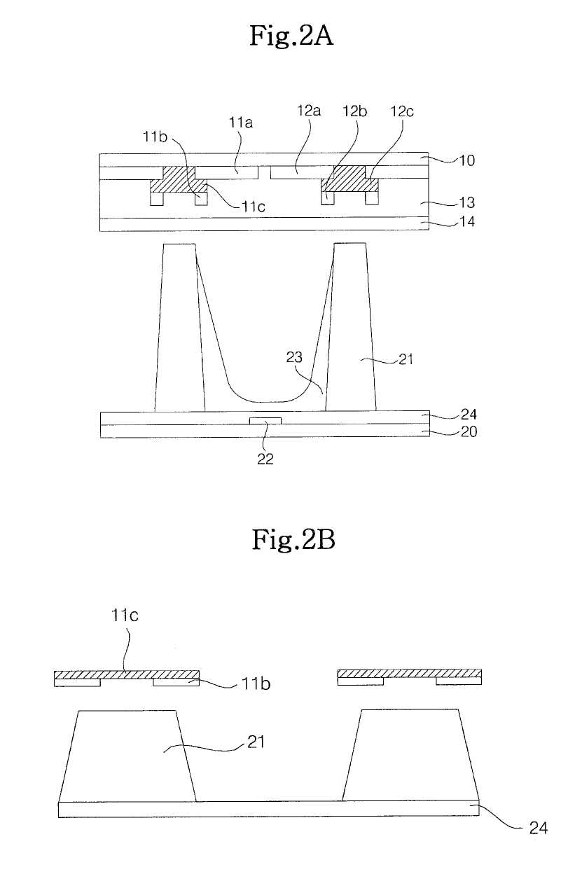

FIG. 2A shows a first embodiment of the sectional structure of the PDP, and FIG. 2B schematically shows the sectional structure of the panel in FIG. 2A.

With reference to FIGS. 2A and 2B, the black matrixes 11c and 12c are positioned between the ITO transparent electrodes 11a and 12a and the bus electrodes 11b and 12b, and may be integrally formed with the bus electrodes 11b and 12b.

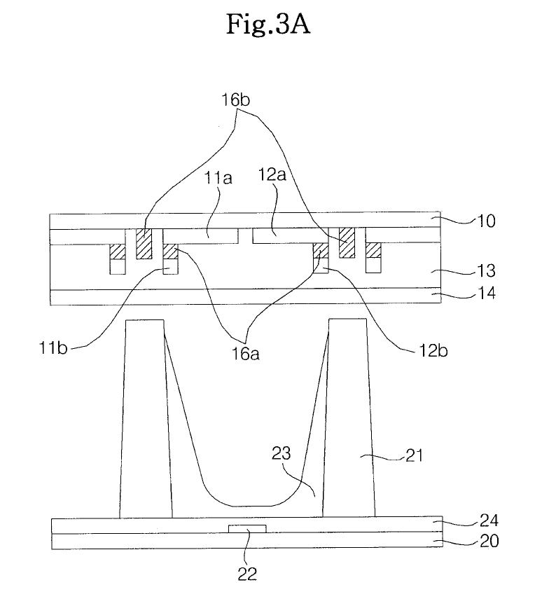

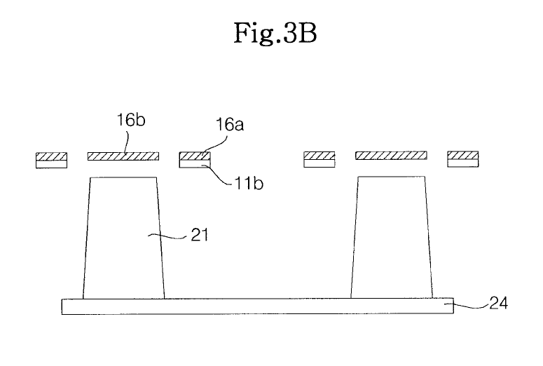

FIG. 3A shows a second embodiment of the sectional structure of the PDP and FIG. 3B schematically shows the sectional structure of the panel in FIG. 3A.

With reference to FIG. 3A, the black matrixes 16a and 16b are separately formed such that first black matrixes 16 are positioned between the ITO transparent electrodes 11a and 12a and the bus electrodes 11b and 12b and second black matrixes 16b are formed at positions to overlap with the barrier ribs 21. The separation type black matrixes as shown in FIG. 3A can improve luminance by increasing external emission of light of the panel generated by discharges.

With reference to FIG. 3B, the bus electrodes 11b and 12b are positioned within the discharge cell so as not to overlap with upper edges of the barrier ribs 21, so a discharge firing voltage can be reduced, and thus, power consumption for driving the panel can be also reduced.

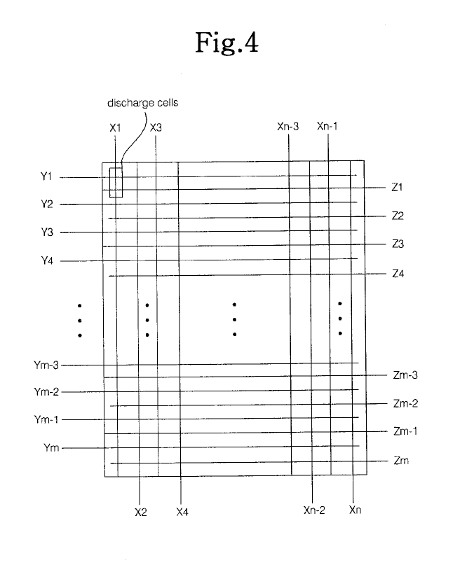

FIG. 4 is a layout view showing a first embodiment of an electrode disposition of the PDP according to the present invention.

The plurality of discharge cells are formed at crossings of scan electrode lines Y1˜Ym, sustain electrode lines Z1˜Zm, and address electrode lines X1˜Xn.

The scan electrode lines Y1˜Ym may be sequentially driven or simultaneously driven, and the sustain electrode lines Z1˜Zm may be simultaneously driven. The address electrode lines X1˜Xn may be divided into the odd number lines and even number lines so as to be driven or may be sequentially driven.

The electrode disposition as shown in FIG. 4 refers to merely the first embodiment of the electrode disposition of the PDP according to the present invention, so the present invention is not limited to the electrode disposition and the driving method of the PDP as shown in FIG. 4.

For example, the scan electrode lines Y1˜Ym may be scanned by twos simultaneously according to dual scanning or double scanning.

Herein, the dual scanning is a scanning method in which the PDP is divided into upper and lower areas and one scan electrode line belonging to the upper area and one scan electrode line belonging to the lower area are simultaneously driven. The double scanning is a scanning method in which two consecutively disposed scan electrode lines are simultaneously driven.

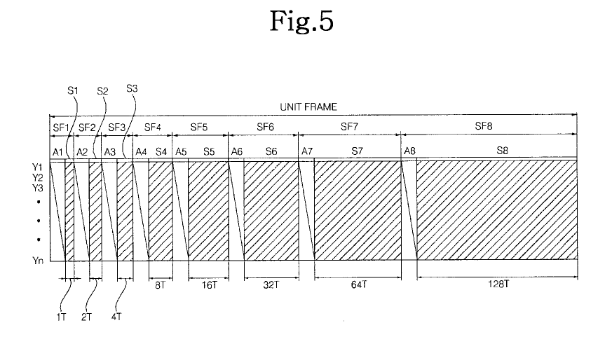

FIG. 5 is a timing view showing a first embodiment of a method of time division of one frame into several sub-fields.

With reference to FIG. 5, in order to represent gray scales, a unit frame may be divided into a certain number of sub-fields, e.g., eight sub-fields SF1 to SF8. Respective sub-fields are divided into a reset period (not shown), address periods A1˜A8, and sustain periods S1˜S8.

The reset period may be omitted in at least one of the sub-fields. For example, the reset period may be present only at a first sub-field or may be present only at a middle sub-field between the first sub-field and the entire sub-fields.

During the respective address periods A1˜A8, a display data signal is supplied to the address electrodes X, and corresponding scan pulses are sequentially supplied to the scan electrodes Y.

During the sustain periods S1˜S8, the sustain pulses are alternately supplied to the scan electrodes Y and the sustain electrodes Z to cause sustain discharges in the discharge cells in which wall charges are formed during the address periods A1˜A8.

Luminance of the PDP is proportional to the number of sustain discharge pulses of the unit frame during the sustain discharge periods S1˜S8.

The number of sustain pulses allocated to each sub-field may be determined to be variable according to a weight value of each sub-field at an APC (Automatic Power Control) stage.

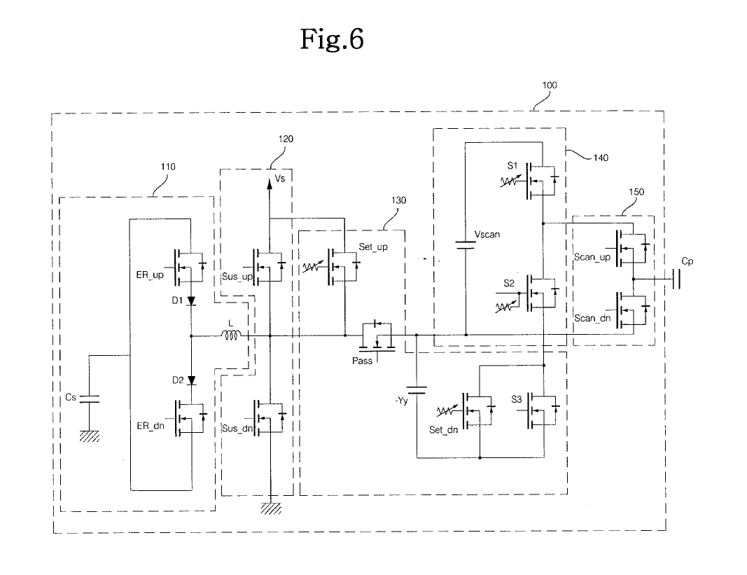

FIG. 6 is a circuit diagram showing a first embodiment of a scan driving circuit of a plasma display apparatus according to the present invention.

With reference to FIG. 6, the scan driving circuit 100 of the plasma display apparatus includes an energy recovery unit 100, a sustain driver 120, a reset driver 130, a scan driver 140, and a scan IC 150.

The energy recovery unit 110 includes a source capacitor Cs that recovers energy which has been supplied to a panel capacitor Cp and supplies it, an energy supply switch ER_up which is turned on to allow the energy stored in the source capacitor Cs to be supplied to the panel capacitor Cp, an energy recovery switch ER_dn which is turned on to recover the energy from the panel capacitor Cp, and an inductor (L) that forms a resonance circuit with the panel capacitor Cp.

The energy recovery unit 110 includes a first diode D1 having an anode connected to a source of the energy supply switch ER_up and a cathode connected to one side of the inductor (L), and a second diode D2 having a cathode connected with a drain of the energy recovery switch ER_dn and an anode connected to one side of the inductor (L).

The sustain driver 120 includes a sustain voltage power Vs that supplies a sustain voltage Vs during the sustain period when a setup signal is applied during the reset period, a sustain-up switch Sus_up which is turned on to allow the sustain voltage Vs to be applied to the panel capacitor Cp, and a sustain-down switch Sus_dn which is turned on to allow a ground voltage level to be applied to the panel capacitor Cp.

The reset driver 130 includes a setup switch Set_up which is turned on to supply a rising signal that gradually rises up to the sustain voltage Vs to the panel capacitor Cp during the reset period, and a pass switch Pass that forms a current pass path together with a set-down switch Set-dn, which is turned on to supply a falling signal which gradually falls to a negative polarity voltage −Vy, and the panel capacitor Cp.

Herein, variable resistors that can control resistance values are connected with gates of the set-up switch Set_up and the set-down switch Set_dn, so that the rising signal and the falling signal are supplied to the panel capacitor Cp according to controlling of the resistance value.

The scan driver 140 includes a first switch S1 which is connected with a scan voltage power source Vscan and supplies a signal rising up to the scan voltage Vscan to the panel capacitor Cp during the reset period, and second and third switches S2 and S3 which supply a first signal, which gradually falls, to the panel capacitor Cp during the address period.

The scan IC 150 includes a scan-up switch Scan_up turned on to apply the scan voltage Vscan to the panel capacitor Cp and a scan-down switch Scan_dn turned on to apply a ground voltage to the panel capacitor Cp.

Herein, when the second switch S2 is turned on during the address period, the third switch S3 is also turned on, allowing the negative polarity voltage source −Yy to form a current pass to the panel capacitor Cp connected with the scan-up switch Scan_up of the scan IC 150 and supply the first signal that falls to the negative polarity voltage −Yy.

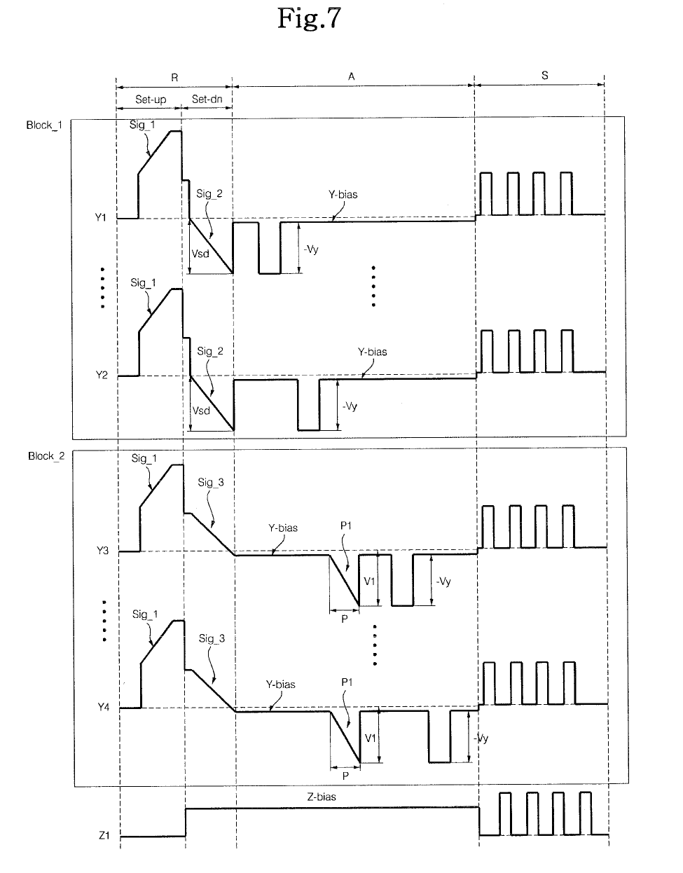

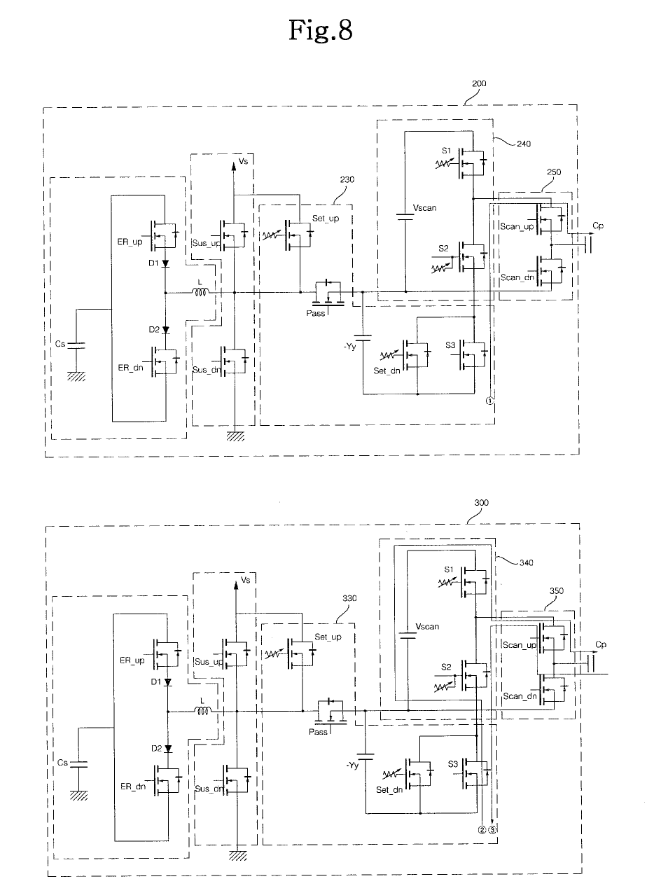

FIG. 7 is a timing view showing a first embodiment of driving waveforms of the PDP according to the present invention. FIG. 8 is a circuit diagram showing an operation of the scan driving circuit when the falling signal and the first signal are applied in the first embodiment of FIG. 7.

In the first embodiment of the present invention, four scan electrodes are shown to be described, but the number of scan electrodes is not limited and FIG. 8 will be partially described additionally when descriptions are made with reference to FIG. 7.

As shown in FIG. 7, as for driving waveforms of the PDP, the reset period (R) includes a set-up period during which rising signals Sig_1 which gradually rise are applied and a set-down period during which falling signals Sig_2 which gradually fall are applied.

The plurality of scan electrodes Y1˜Y2 and Y3˜Y4 are divided into at least two blocks in order to differently apply driving signals thereto.

The at least two blocks include a first block Block_1 including the scan electrodes Y1 and Y2 and a second block Block_2 including the scan electrodes Y3 and Y4.

The plurality of scan electrodes can be divided into the at least two blocks or more, and hereinafter, the case where the scan electrodes are driven according to single scanning will be described. Herein, the single scanning refers to a driving method in which only one scan electrode is scanned at the same time during the address period in driving the plasma display apparatus.

FIG. 8 shows a first scan driving circuit 200 that applies driving waveforms to the scan electrodes Y1 and Y2 of the first block Block_1 and a second scan driving circuit 300 that applies driving waveforms to the scan electrodes Y3 and Y4 of the second block Block_2.

Namely, the first and second scan driving circuits 200 and 300 apply the driving waveforms to the first and second blocks Block_1 and Block_2. The first and second scan driving circuits 200 and 300 have substantially the same structure as that of the scan driving circuit shown in FIG. 6, so descriptions on the same parts will be omitted or briefly made.

As the rising signals Sig_1 and the falling signals Sig_2 are applied to the plurality of scan electrodes Y1˜Y2 and Y3˜Y4 included in the first and second blocks Block_1 and Block_2, negative polarity wall charges are accumulated in the scan electrodes, while positive polarity wall charges are accumulated in the sustain electrodes Z1.

Herein, the slopes, the maximum and minimum voltage values, and start and end points of the rising signals Sig_1 and the falling signals Sig_2 applied to all the scan electrodes Y1˜Y2 and Y3˜Y4 are substantially the same at the plurality of scan electrodes Y1˜Y2 and Y3˜Y4.

That is, the falling signals Sig_2 applied to the scan electrodes Y1˜Y2 of the first block Block_1 fall from the maximum (highest) voltage of the rising signals Sig_1 to ground voltages and then to the negative polarity voltages −Vy.

However, falling signals Sig_3 applied to the scan electrodes Y3˜Y4 of the second block Block_2 fall from the maximum voltage of the rising signals Sig_1 by the amount of scan voltage to Y-bias voltages. Herein, the Y-bias voltages have a value smaller than the ground level.

With reference to FIG. 8, the first scan driving circuit 200 applies drive signals to the scan electrodes Y1˜Y2 of the first block Block_1 and the second scan driving circuit 200 applies drive signals to the scan electrodes Y3˜Y4 of the second block Block_2.

Herein, in order to apply the falling signals Sig_2 to the panel capacitor Cp, namely, to the scan electrodes Y1˜Y2, in the first scan driving circuit 200, the scan-up switch Scan_up of the scan IC 250, the second switch S2 of the scan driver 240, and the third switch S3 of the reset driver 230 are turned on.

That is, in the first scan driving circuit 200, a pass path \textcircled{1} is formed to allow the falling signals Sig_2 to be applied to the panel capacitor Cp.

In order to apply the falling signals Sig_3 to the panel capacitor Cp, namely, to the scan electrodes Y3˜Y4, in the second scan driving circuit 300, the scan-up switch Scan_up of the scan IC 350, the first switch S1 of the scan driver 340, and the third switch S3 of the reset driver 330 are turned on.

That is, in the second scan driving circuit 300, a pass path \textcircled{2} is formed to allow the falling signals Sig_3 that fall to the Y-bias voltage with the value smaller than the ground level to be applied to the panel capacitor Cp.

Meanwhile, a Z-bias voltage is applied to the sustain electrodes Z1 when the falling signals Sig_2 are applied to the plurality of scan electrodes Y1˜Y2 and Y3˜Y4, in order to stably accumulate wall charges therein so as to be ready for subsequent address discharges.

During the address period (A), after the Y-bias voltages lower than the ground voltage level are applied to the scan electrodes Y1˜Y2 of the first block Block_1, the scan signals −Vy are sequentially applied to select discharge cells to be turned on or off.

Also, the Y-bias voltages lower than the ground voltage level are applied to the scan electrodes Y3˜Y4 of the second block Block_2, and when a certain time lapses, the gradually falling first signals P1 are applied and the scan signals −Vy for selecting discharge cells to be turned on or off are applied.

With reference to FIG. 8, in the second scan driving circuit 300, a pass path \textcircled{3} is formed to apply the first signals P1. Herein, comparatively, the first scan driving circuit 200 does not apply the first signal P1.

In other words, in the second scan driving circuit 300, in order to apply the first signals P1 to the scan electrodes Y3˜Y4 of the second block Block_2 at the voltage level of the falling signals Sig_3, the scan-up switch Scan_up of the scan IC 350, the second switch S2 of the scan driver 340, and the third switch S3 of the reset driver 330 are turned on.

Herein, the first signals P1 serve to prevent a loss of the wall charges formed in the scan electrodes Y3˜Y4 of the second block Block_2.

That is, generally, the scan signals −Vy are applied later to the scan electrodes Y3˜Y4 of the second block Block_2 than to the scan electrodes Y1˜Y2 of the first block Block_1, so the wall charges accumulated during the reset period (R) are lost. Thus, considering such loss of the wall charges, the first signals P1 generate weak discharges between the scan electrodes and the sustain electrodes to maintain the wall charges required for the address discharges until the scan signals −Vy are applied.

Preferably, each minimum (the lowest) voltage of the first signals P1 has substantially the same voltage level V1 and slope as those of the minimum voltage Vsd of the falling signals Sig_2, and has a width (P) of about 5(s to 20(s.

Herein, if amplitude of the first signals P1 is smaller than 5(s, it may be difficult to form such a sufficient amount of wall charges as to reliably generate the address discharges, whereas if the amplitude of the first signals P1 is larger than 20(s, a driving time margin may deteriorate. That is, the amplitude of the first signals P1 within the range of about 5(s to 20(s would ensure the stable address discharge during the address period and be advantageous for the driving time margin.

In addition, the first signals P1 are applied to all the scan electrodes belonging to the second block Block_2 at the same time, and have substantially the same amplitude (P) and slope. In this respect, an interval between a time point at which the application of the first signals P1 is terminated and a time point at which the scan signals −Vy starts to be applied is increased as scanning occurs later in the order.

The plasma display apparatus according to the first embodiment of the present invention is advantageous in that, with the scan electrodes divided into the first and second blocks, the first signals are applied to prevent a loss of the wall charges accumulated in the scan electrodes as the scan signals are applied to the second block relatively later than to the first block, to thereby prevent misfiring and improve address discharges.

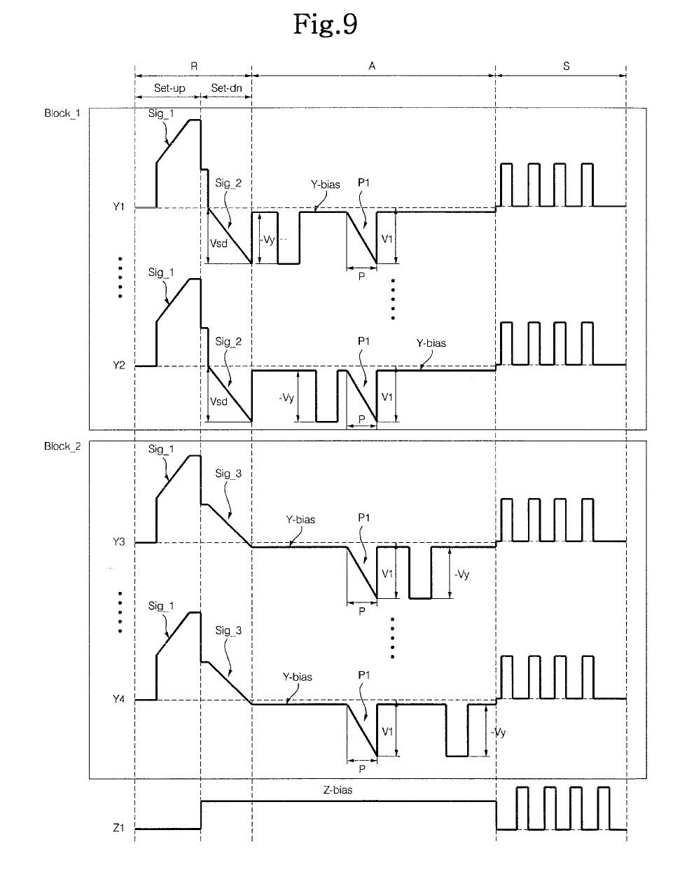

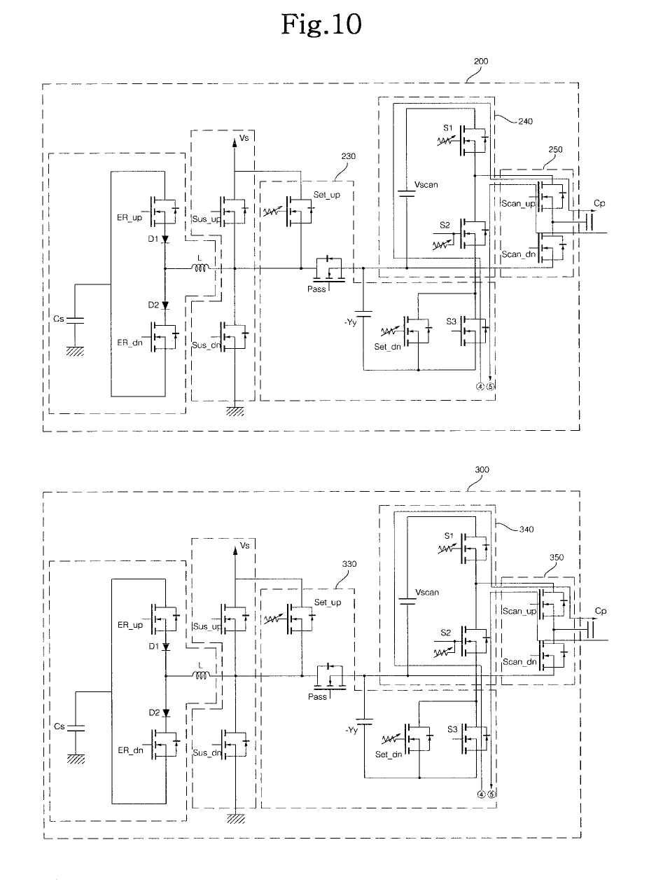

FIG. 9 is a timing view showing a second embodiment of driving waveforms of the PDP according to the present invention, and FIG. 10 is a circuit diagram showing operations of the scan driving circuit when the falling signals and first and third signals are applied in the second embodiment of FIG. 9.

With reference to FIG. 9, in describing the driving waveforms of the PDP according to the second embodiments, the repeated parts as those of the first embodiment will be briefly described or its description will be omitted.

In the second embodiment of the present invention, after the scan voltages −Vy are applied to the scan electrodes Y1˜Y2 of the first block Block_1, the first signals P1 as described with reference to FIG. 7 are applied. In addition, the falling signals Sig_3 applied during the reset period of the second block Block_2 fall from the maximum voltages of the rising signals Sig_1 by the amount of scan voltage to the Y-bias voltages lower than the ground level. Likewise, an application start time point, an application end time point, amplitude (P), voltage values, slopes, etc., of the first signals P1 applied to the first and second blocks Block_1 and Block_2 are substantially the same at the plurality of scan electrodes.

Herein, the first signals P1 applied to the first block Block_1 serve to prevent a loss of wall charges generated after the address discharge occurs by the scan voltages −Vy, before the sustain period (S).

With reference to FIG. 10, the first scan driving circuit 200 applies drive signals to the scan electrode Y1˜Y2 of the first block Block_1 and the second driving circuit 300 applies drive signals to the scan electrodes Y3˜Y4 of the second block Block_2.

Herein, the falling signals Sig_2 of the first block Block_1 and the falling signals Sig_3 of the second block Block_2 as shown in FIG. 9 are substantially the same as the falling signals Sig_2 and Sig_3 as shown in FIG. 7, and the first and second scan driving circuits 200 and 300 apply the falling signals Sig_2 and Sig_3 through a pass path \textcircled{4}, respectively.

The first signals P1 are applied to the first and second blocks Block_1 and Block_2, and in this case, the first and second scan driving circuits 200 and 300 form the pass paths \textcircled{5} which are substantially the same.

Namely, in order to apply the first signals P1 to the scan electrodes Y1˜Y2 and Y3˜Y4 of the first and second blocks Block_1 and Block_2, in the second scan driving circuit 300 at the voltage level of the falling signals Sig_3, the scan-up switch Scan_up of the scan IC 350, the second switch S2 of the scan driver 340, and the third switch S3 of the reset driver 330 are turned on.

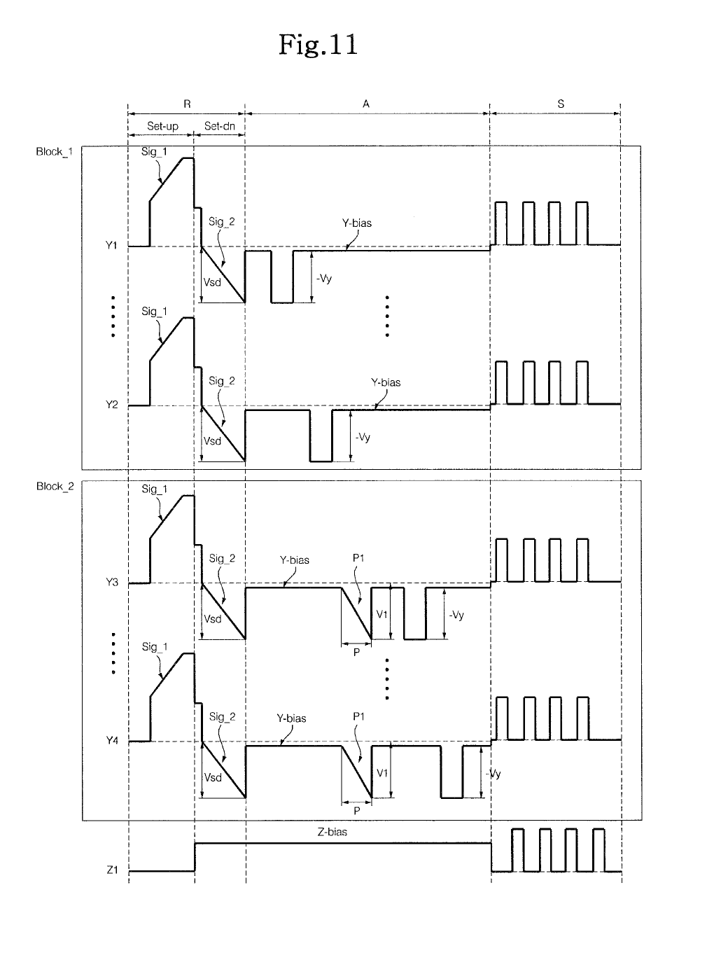

FIG. 11 is a timing view showing a third embodiment of driving waveforms of the PDP according to the present invention.

In FIG. 11, the repeated parts as those in FIGS. 7 and 9 as described above will be briefly explained or a detailed description therefor will be omitted.

With reference to FIG. 11, as for driving waveforms of the PDP according to the third embodiment of the present invention, the reset period (R) includes a set-up period during which the rising signals Sig_1 which gradually rises is applied and a set-down period during which the falling signals Sig_2 which gradually falls is applied.

The plurality of scan electrodes Y1˜Y2 and Y3˜Y4 are divided into at least two blocks in order to differently apply driving signals thereto.

That is, the falling signals Sig_2 applied to the scan electrodes Y1˜Y2 of the first block Block_1 fall from the maximum (highest) voltage of the rising signals Sig_1 to ground voltages and then to the negative polarity voltages −Vy.

However, the falling signals Sig_2 applied to the scan electrodes Y3˜Y4 of the second block Block_2 fall from the maximum voltage of the rising signals Sig_1 by the amount of scan voltage to Y-bias voltages. Herein, the Y-bias voltages have a value smaller than the ground level.

Herein, the falling signals (Sig_2) applied to the first and second blocks Block_1 and Block_2 have the same slopes and voltage levels Vsd. Also, the falling signals Sig_2 and the first signals p1 have substantially the same slopes.

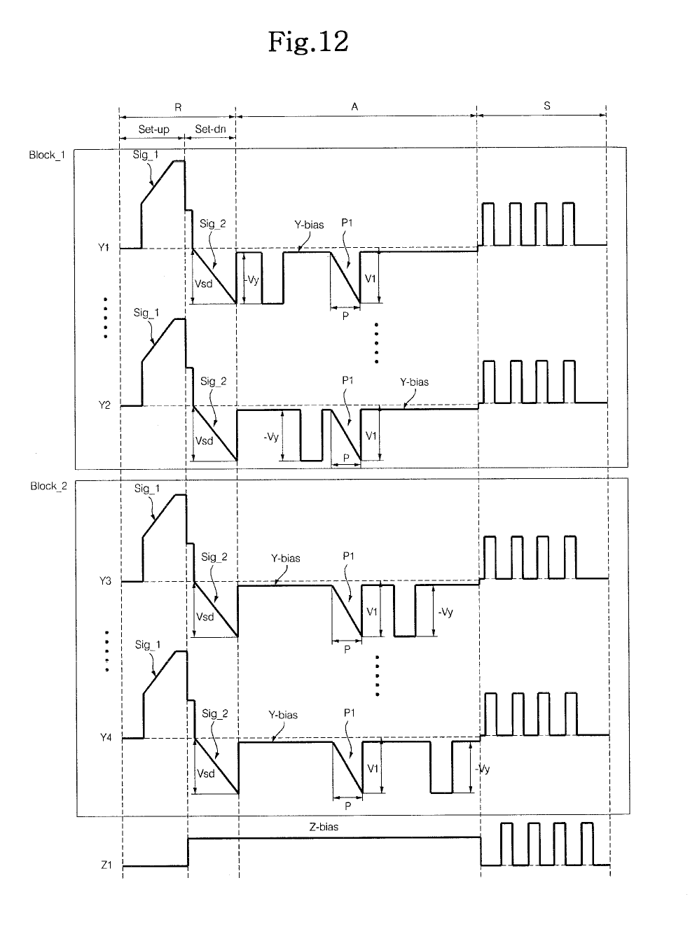

FIG. 12 is a timing view showing a fourth embodiment of driving waveforms of the PDP according to the present invention.

In FIG. 12, the repeated parts as those in FIGS. 7 and 9 as described above will be briefly explained or a detailed description therefor will be omitted.

In FIG. 12, likewise as in FIGS. 7 and 9 as described above, after the scan voltages −Vy are applied to the scan electrodes belonging to the first block Block_1, the first signals P1 as described above with reference to FIG. 7 are applied. Herein, the application start time point, the application end time point, the amplitude (P), and the slope, etc., of the first signals P1 can be substantially the same at every scan electrode of the first block Block_1 or can be substantially the same at every scan electrode of the first and second blocks Block_1 and Block_2. Accordingly, in case of the scan electrodes of the first block, an interval between the application end time point of the scan signals −Vy and the application start time point of the first signals P1 is reduced as scanning occurs later in the order.

Herein, the first signals P1 applied to the first block Block_1 serve to prevent a loss of wall charges generated after the address discharge occurs by the scan voltages −Vy, before the sustain period (S).

Meanwhile, in FIGS. 7, 9, 11, and 12, an application start time point of the Z-bias voltage applied to the sustain electrodes Z1 is substantially the same as the start time point of the set-down period Set-dn.

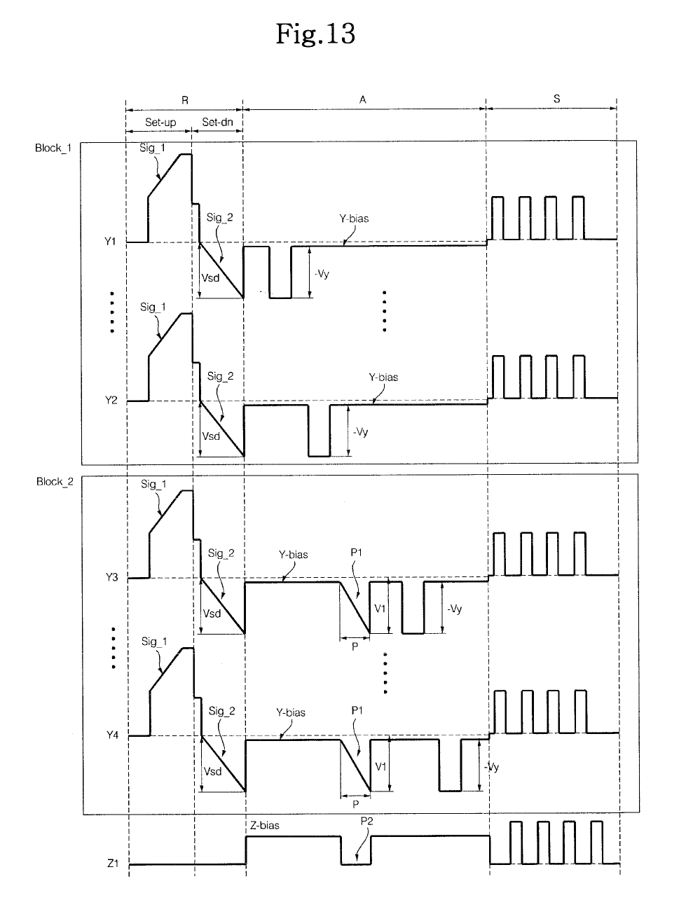

FIG. 13 is a timing view showing a fifth embodiment of driving waveforms of the PDP according to the present invention.

With reference to FIG. 13, the driving waveforms according to the fifth embodiment are the same as those shown in FIG. 7 as described above, except that a time point at which the Z-bias voltage is applied to the sustain electrodes Z1 and application of a second signal P2, which corresponds to the first signals P1 applied to the scan electrodes, to the sustain electrodes Z1, so a detailed description therefor will be omitted.

That is, in the fifth embodiment of the present invention, the Z-bias voltage is applied to the sustain electrodes Z1 at substantially the same time when the application of the falling signals Sig_2 is terminated or at the end time point of the set-down Set-dn period. When the first signals P1 are applied to the scan electrodes of the second block Block_2, the second signal P2 having amplitude which is the same as or larger than that of the first signal is applied to the sustain electrodes Z1.

Herein, the second signal P2 may have a square wave and its voltage is changed starting from the Z-bias voltage to end in a ground level voltage. Preferably, the application start time point of the second signal P2 is the same as or slightly faster than that of the first signals P1 and the application end time point of the second signal P2 is the same as or slightly later than that of the first signal P1. Otherwise, there is a possibility that noise may be generated in the first signals P1 applied to the scan electrodes due to a sharp voltage change at the sustain electrodes. Amplitude of the second signal P2 is within the range of 10 μs to 25 μs, and preferably, within the range of about 5 μs to 20 μs, which is the same as that of the first signals P1.

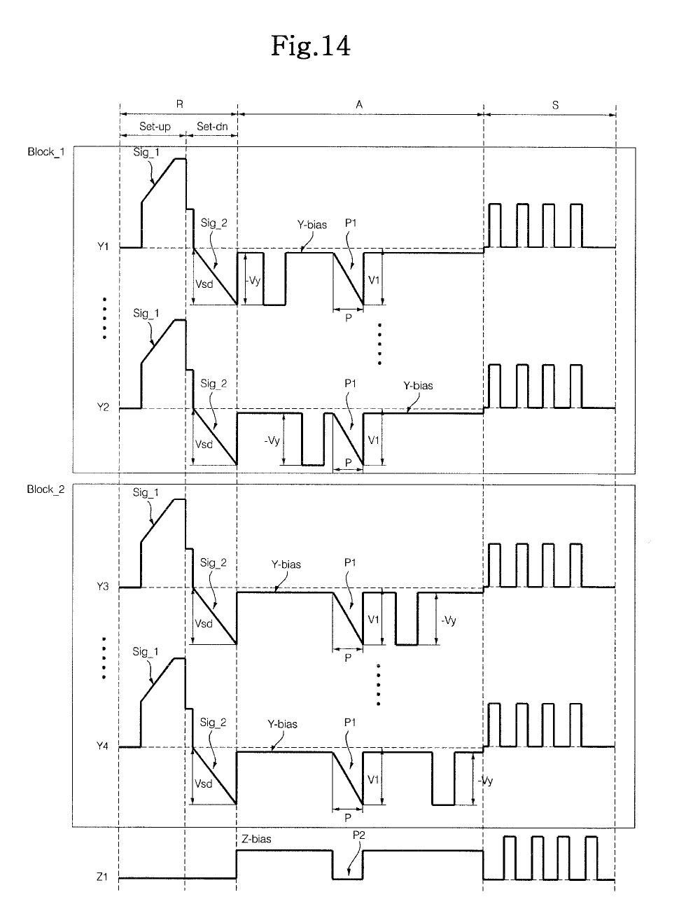

FIG. 14 is a timing view showing a sixth embodiment of driving waveforms of the PDP according to the present invention.

As can be understood with reference to FIGS. 8 to 13, in the sixth embodiment of the present invention as shown in FIG. 14, the first signals P1 are simultaneously applied to the first and second blocks Block_1 and Block_2, the second signal P2 is applied to correspond to the first signals P1, and the Z-bias voltage is applied at substantially the same time when the application of the falling signals Sig_2 is terminated.

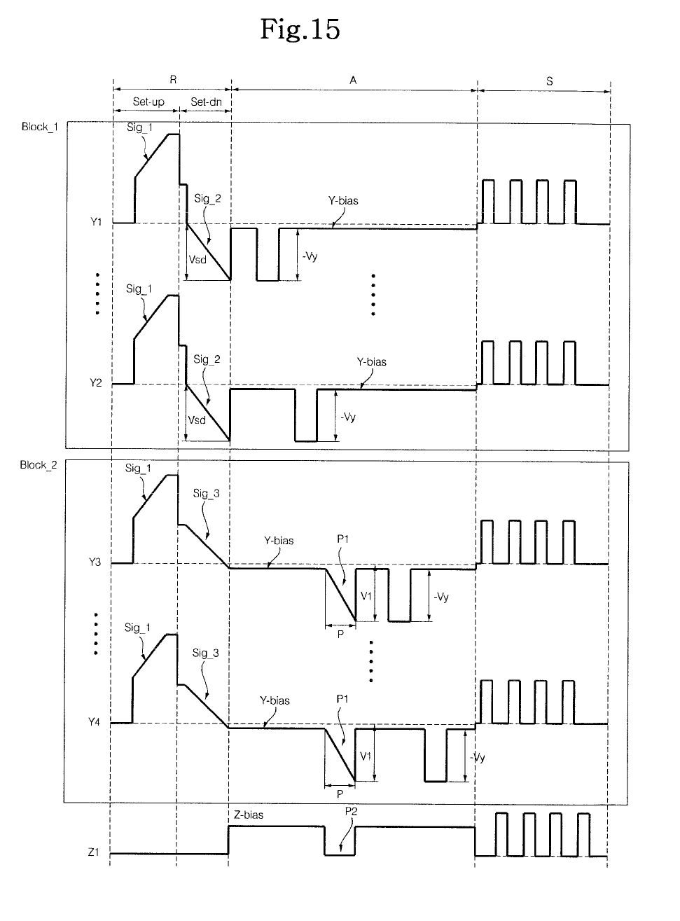

FIG. 15 is a timing view showing a seventh embodiment of driving waveforms of the PDP according to the present invention.

As can be understood with reference to FIGS. 11 and 13, in the seventh embodiment of the present invention as shown in FIG. 15, such falling signals Sig_3 as shown in FIG. 9 are applied to the second block Block_2, the second signal P2 is applied to correspond to the first signals P1, and the Z-bias voltage is applied substantially when the application of the falling signals Sig_3 is terminated.

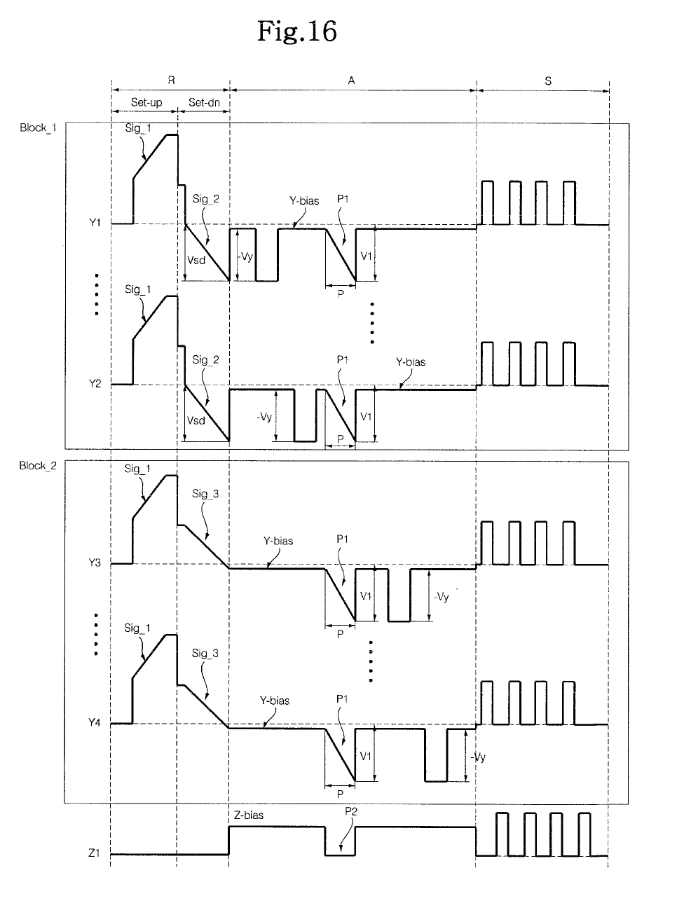

FIG. 16 is a timing view showing an eighth embodiment of driving waveforms of the PDP according to the present invention.

As can be understood with reference to FIGS. 12 and 13, in the eighth embodiment of the present invention as shown in FIG. 16, the same falling signals Sig_3 as shown in FIG. 9 is applied to the second block Block_2, the first signals P1 are applied to the first and second blocks Block_1 and Block_2, the second signal P2 is applied to correspond to the first signal P1, and the Z-bias voltage is applied substantially when the application of the falling signals Sig_3 is terminated.

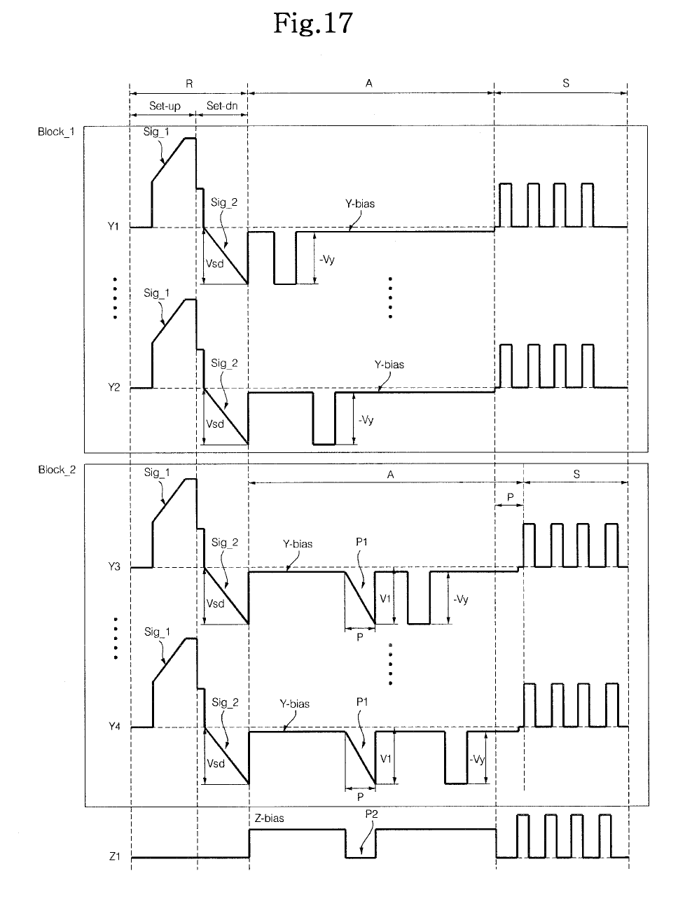

FIG. 17 is a timing view showing a ninth embodiment of driving waveforms of the PDP according to the present invention.

The driving waveforms as shown in FIG. 17 are the same as those as shown in FIG. 11 except that the address period (A) during which scan signals are applied to the scan electrodes of the second block Block_2 extends by the amplitude of the first signal P1. Accordingly, the sustain period (S) at the first block Block_1 and the address period (A) at the second block Block_2 partially overlap each other, and the sustain period (S) at the first block Block_1 is longer than the sustain period (S) at the second block Block_2. However, as shown in FIG. 15, the sustain periods (S) may be controlled to be the same at the first and second blocks Block_1 and Block_2.

Meanwhile, the partial overlap of the address period (A) and the sustain period (S) as long as the first signal P1 between blocks can be also applied in the same manner for the cases as shown in FIGS. 7, 9, and 13.

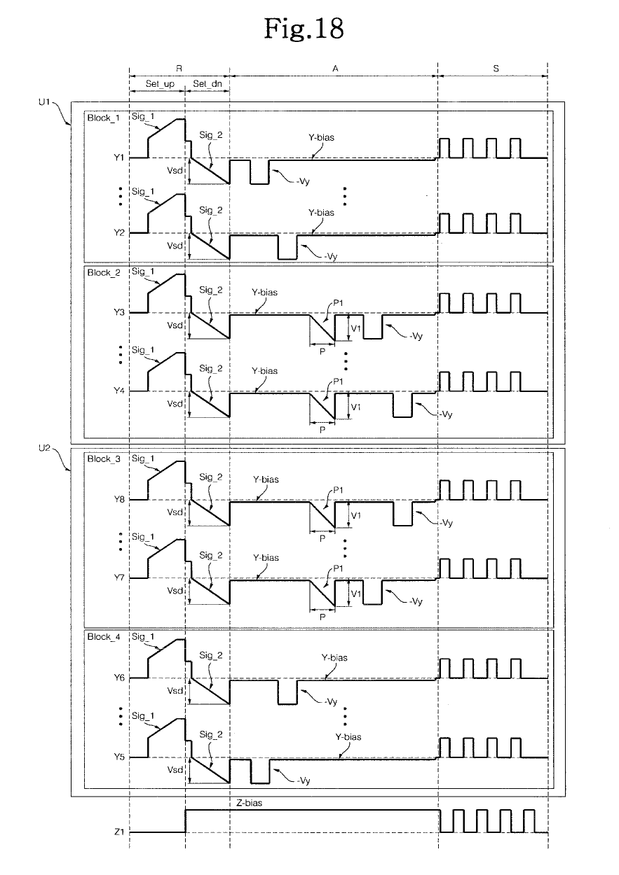

FIG. 18 is a timing view showing a tenth embodiment of driving waveforms of the PDP according to the present invention.

In FIG. 18, detailed description for the repeated parts as those in FIGS. 7 to 17 will be omitted.

As shown in FIG. 18, the plurality of scan electrodes Y1 to Y8 are divided into first and second sections U1 and U2 and the driving waveforms of the PDP according to the present invention are applied according to the dual-scanning method. Herein, in the first section U1, drive signals are applied in the order from the first block Block_1 to the second block Block_2, and in the second section U2, the drive signals are applied in the order from the fourth block Block_4 to the third block Block_3, respectively.

Thus, because the scan signals are applied to the scan electrodes Y3˜Y4 and Y7˜Y8 included in the second and third blocks Block_2 and Block_3 later than to the scan electrodes Y1˜Y2 and Y5˜Y6 included in the first and fourth blocks Block_1 and Block_4, the wall charges accumulated during the reset period (R) are lost, the first signals P1 are applied to supplement the amount of the wall charges to maintain the wall charges until the scan signals −Vy are applied.

Preferably, the PDP employing the dual-scanning method as described with reference to FIG. 18 has such a structure that the address electrodes (Z) are physically divided at the central portion. In addition, a scan electrode driver may be connected to each of the blocks Block1 to Block4. Also, besides the waveforms as shown in FIG. 18, those driving waveforms as shown in FIGS. 7 to 17 can be also applied.

Meanwhile, the first signals P1 or the second signals P2 as shown in FIGS. 7 to 18 are preferably applied to sub-fields with a low gray scale weight value. The reason is because a sub-field with a high gray scale weight value uses wall charges accumulated by the discharge of the sustain pulses applied to a previous sub-field even during the reset period, it has the probability of address misfiring lower than that of the sub-field with a low gray scale weight value. For example, the first signal P1 or the second signal P2 is preferably applied to at least one of the first to fourth sub-fields in the time order of the sub-fields.

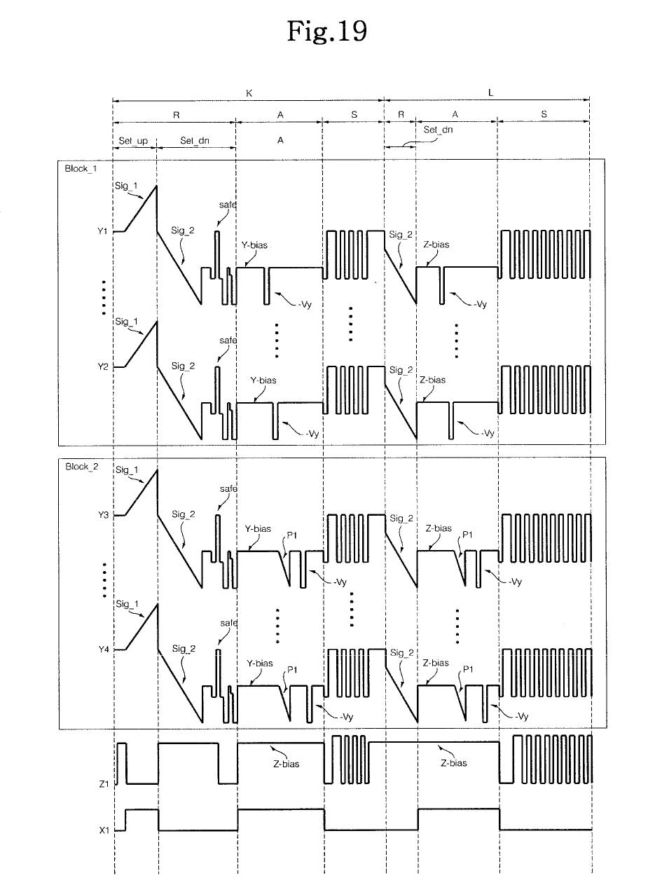

FIG. 19 is a timing view showing an eleventh embodiment of driving waveforms of the PDP according to the present invention.

With reference to FIG. 19, as for the driving waveforms of the PDP according to the eleventh embodiment of the present invention, among the plurality of the sub-fields, the reset period (R) of the K sub-field includes a set-up period during which the rising signals (Sig_1) that rise gradually are applied to the plurality of scan electrodes Y1˜Y2 and Y3˜Y4 and the set-down period during which the falling signals Sig_2 that fall gradually are applied to the scan electrodes Y1˜Y2 and Y3˜Y4.

Herein, the plurality of scan electrodes Y1˜Y2 and Y3˜Y4 are divided into at least two blocks in order to differently apply drive signals thereto.

The at least two blocks include a first block Block_1 including the scan electrodes Y1 and Y2 and a second block Block_2 including the scan electrodes Y3 and Y4. The plurality of scan electrodes can be divided into the at least two blocks or more, to which the single scanning or the dual-scanning can be applied.

The rising signals Sig_1 and the falling signals Sig_2 may be applied to the plurality of scan electrodes Y1˜Y2 and Y3˜Y4 of the first and second blocks Block_1 and Block_2, so negative polarity wall charges are accumulated in the scan electrodes Y1˜Y2 and Y3˜Y4, and positive polarity wall charges are accumulated in the sustain electrodes z1.

In this case, when the rising signals Sig_1 are applied to the plurality of scan electrodes Y1˜Y2 and Y3˜Y4 of the first and second blocks Block_1 and Block_2, the positive polarity voltage Z-bias is applied to the address electrodes X in order to restrain misfiring. That is, the positive polarity voltage is applied to the address electrodes (X) only at the sub-fields during which the rising signals Sig_1 are applied to the scan electrodes. Herein, the positive polarity voltage applied to the address electrodes (X) has substantially the same value as that applied to the address electrodes (X) during the address period (A).

During the set-down period, after the falling signals Sig_2 are applied, safe signals are applied before the Y-bias voltage is applied.

During the address period (A), after the Y-bias voltages are applied to the scan electrodes Y1˜Y2 of the first block Block_1, the scan signals −Vy are sequentially applied to select discharge cells to be turned on or off.

In the second block Block_2, after the Y-bias voltages are applied to the scan blocks Y3˜Y4, the first signals P1 are applied with the lapse of a certain time, and then, the scan signals −Vy are applied to select discharge cells to be turned on or off.

Herein, the first signals P1 serve to prevent a relative loss of wall charges formed in the scan electrodes Y3˜Y4 of the second block Block_2 compared with the wall charges formed in the scan electrodes Y1˜Y2 of the first block Block_1.

Meanwhile, the amplitude (P) of the first signals P1 is within the range of about 5 μs to 20 μs based on the same reason as described above with reference to FIG. 7, and the slope of the first signals P1 is substantially the same as that of the falling signals Sig_2.

During the reset period (R) of an L sub-field, unlike the reset period (R) of the K sub-field, no rising signal Sig_1 is applied and only the falling signals Sig_2 with voltage values that gradually fall are applied.

In such a sub-field as the L sub-field in which no rising signal is applied, no positive polarity voltage is supplied to the address electrodes X during the reset period (R).

Likewise as shown in FIG. 12 as described above, substantially the same signals as the first signals P1 applied to the second block Block_2 may be applied to the scan electrodes Y1˜Y2 of the first block Block_1 after the scan signals −Vy are applied.

As shown in FIG. 19, in at least one of the plurality of sub-fields constituting a single frame, the safe signals may be applied between the application end time point of the falling signals Sig_2 and the application start time point of the scan pulses −Vy in order to stabilize discharging. The safe signals can control the state of the wall charges to thus cause stable address discharges during the address period (A).

According to the embodiment(s) of the present invention, scan electrodes are divided into two groups: one group including upper scan electrodes and the other group including lower scan electrodes. Then, the scan electrodes are driven in units of the groups. However, the scan electrodes may be divided into a group including odd-numbered scan electrodes and a group including even-numbered scan electrodes and may thus be driven in units of the odd-numbered scan electrode group and the even-numbered scan electrode group.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto and their equivalents.

What is claimed is:

1. A plasma display driving method wherein a plurality of scan electrodes of a plasma display panel are divided into first and second blocks, a single frame of an image displayed on the plasma display panel comprises at least one sub-field comprising at least one of a reset period, an address period, and a sustain period, and a first signal having a gradually falling potential (a voltage value) is applied to at least one scan electrode included in at least one of the first and second blocks before a scan pulse is applied.

2. The method of claim 1, wherein the first signal is applied to at least one scan electrode included in the second block which is scanned later than the first block in terms of the scanning order.

3. The method of claim 1, wherein amplitude of the first signal is with the range of about 5 μs to 20 μs.

4. The method of claim 1, wherein when the first signal is applied to at least one scan electrode during the address period, a second signal with a positive polarity voltage or a ground (GND) voltage is applied to a sustain electrode.

5. The method of claim 4, wherein in case that the second signal with the positive polarity voltage is applied, the signal applied to the sustain electrode rises from the ground voltage to the positive polarity voltage to correspond to a time point at which application of the falling signal having the gradually reduced voltage value starts before the first signal is applied to at least one of the scan electrode.

6. The method of claim 4, wherein in case that the second signal with the ground voltage is applied, the signal applied to the sustain electrode rises from the ground voltage to the positive polarity voltage to correspond to a time point at which the application of the falling signal having the gradually reduced voltage value is terminated before the first signal is applied to at least one of the scan electrode.

7. The method of claim 4, wherein amplitude of the second signal is substantially the same as or larger than that of the first signal.

8. The method of claim 7, wherein the second signal is applied substantially at the same time when the first signal is applied, or applied before the first signal is applied.

9. The method of claim 1, wherein after the scan pulse is applied to at least one of the scan electrode included in the first block which is faster scanned than the second block in terms of the scanning order, a third signal having a waveform, an amplitude, a slope, a minimum voltage, and a maximum voltage, one of which being substantially the same as that of the first signal, is applied.

10. The method of claim 1, wherein the application start time point and the application end time point of the first and third signals are substantially the same.

11. The method of claim 1, wherein the sustain period of the first block and the address period of the second block partially overlap to correspond to the amplitude of the first signal.

12. A plasma display apparatus comprising:
a plasma display panel that displays an image based on at least one sub-field comprising at least one of a reset period, an address period, and a sustain period and comprises a plurality of scan electrodes divided into first and second blocks; and
a scan driving circuit that applies respective drive signals to at least one scan electrode included in each of the first and second blocks,
wherein the scan driving circuit comprises:
a first scan driver that applies the drive signals to at least one scan electrode included in the first block; and
a second scan driver that applies a first signal having a gradually reduced voltage value to at least one scan electrode included in the second block before a scan signal, among the drive signals, is applied.

13. The apparatus of claim 12, wherein the second scan driver applies the first signal to at least one scan electrode included in the second block which is later scanned than the first block in terms of scanning order.

14. The apparatus of claim 12, wherein when the first signal is applied, the scan driving circuit applies a second signal having a positive polarity voltage or a ground voltage to a sustain electrode.

15. The apparatus of claim 12, wherein amplitude of the first signal is within the range of about 5 μs to 20 μs

16. The apparatus of claim 14, wherein the second signal is applied substantially at the same time when the first signal is applied, or applied before the first signal is applied.

17. The apparatus of claim 17, wherein amplitude of the second signal is substantially the same as or larger than that of the first signal.

18. The apparatus of claim 14, wherein the first scan driver applies a third signal having a waveform, an amplitude, a slope, a minimum voltage, and a maximum voltage, one of which being substantially the same as that of the first signal, to the at least one scan electrode included in the first block.

19. The apparatus of claim 18, wherein the application start time point and the application end time point of the first and third signals are substantially the same.

20. The apparatus of claim 12, wherein in case that the second signal has the ground voltage, the signal applied to the sustain electrode rises from the ground voltage to the positive polarity voltage to correspond to a time point at which the application of the falling signal having the gradually reduced voltage value is terminated before the first signal is applied.
